(19) United States
(12) Patent Application Publication
(10) Pub. No.: US 2016/0154846 A1
(43) Pub. Date: Jun. 2, 2016

(54) System and Method of Addressing and Accessing Information Using a Keyword Identifier

(71) Applicant: Oyokey Inc., Irving, TX (US)

(72) Inventor: Nitin Dinesh Anand, Irving, TX (US)

(73) Assignee: Oyokey Inc., Irving, TX (US)

(21) Appl. No.: 15/018,243

(22) Filed: Feb. 8, 2016

Related U.S. Application Data
(63) Continuation of application No. 13/066,761, filed on Apr. 25, 2011.

(51) Int. Cl. G06F 17/30; G06F 3/0484

(52) U.S. Cl. CPC G06F 17/30424; G06F 3/0484; G06F 17/30887

(57) ABSTRACT

The present invention relates to a system and method of addressing and accessing information on the Internet comprising of a Keyword Identifier and means to interpret the Keyword Identifier, wherein said means include a Software Protocol and a Keyword Management System. These means include the process of generating a query by the Software Protocol on the basis of the said Keyword Identifier; said query being sent to the system of the domain that the Keyword Identifier belongs to, or any other system that can interpret the query correctly. The Software Protocol then interprets the said query into a Keyword Identifier and selects the data mapped for the Keyword Identifier, which thereafter sends this result to the system using the Keyword Identifier. The Keyword Identifier is created and maintained through an Internet Website system or a Software System running on a Client-Server Computer System, as a means of addressing and accessing their Electronic Resources, using the Keyword Management System.

### CROSS-REFERENCE TO RELATED APPLICATION(S) AND CLAIM OF PRIORITY

The present application is a continuation of U.S. patent application Ser. No. 13/066,761, entitled “System and Method of Addressing and Accessing Information Using a Keyword Identifier,” filed on Apr. 25, 2011. application Ser. No. 13/066,761 is assigned to the assignee of the present application and is hereby incorporated by reference into the present application as if fully set forth herein. The present application hereby claims priority under 35 U.S.C. §120 to U.S. patent application Ser. No. 13/066,761.

### TECHNICAL FIELD

The present invention generally relates to addressing and accessing information on the Internet and other networks. Particularly, the present invention relates to addressing and accessing systems used to address and access information, more particularly defined below as Electronic Resources, which are located on the Internet and other networks (defined later as Distributed Computer Systems) using a unique Keyword Identifier.

### BACKGROUND

The following terms have been defined in the specification to interpret their meaning:

Distributed Computer Systems (DCS)—A worldwide system of interconnected computer networks that facilitate data storage, transmission and exchange. This network comprises of the World Wide Web (WWW), the Intranet, public, private, government, commercial, academic and other networks. This system of worldwide computer networks is commonly referred to as the Internet.

Electronic Resource(s)—Describes any data or application, located on Distributed Computer Systems, in the form of webpages, blogs, text files, Microsoft Word documents, Adobe PDF documents, image files, media files of various formats, executable application or other types of files.

Public Search Engines—Describes an Internet Website System or application that allows users to search for Electronic Resources located on Distributed Computer Systems.

External Keyword—Keyword entered in the search box of Public Search Engines (such as Google.com, Yahoo.com and Bing.com). When this type of Keyword is used, the search for Electronic Resources is done across Distributed Computer Systems and the search results will return Electronic Resources that exist on multiple individual or organizations computer systems that are part of Distributed Computer Systems.

Internal Keyword—Keyword entered in the search box of non-Public Search Engines (such as CNN.com, SAP.com and Cisco.com). When this type of Keyword is used, the search for Electronic Resources is done only on the individual or organizations computer systems and not across Distributed Computer Systems. The search results will return Electronic Resources that exist within said individual or organization computer systems only.

Client-Server Computer System (CSCS)—Devices such as Servers, Personal Computers, Laptops, Notebooks, Tablets, Mobile Devices, Internet TV, Gaming Systems, Security Systems, PIM Consoles, Network Appliances, Data Storage Devices, Transportation On-Board Computers, etc. which are capable of storing data, hosting data, computing, providing and performing various complex services and are able to connect to Distributed Computer Systems. Such a system can perform functions of either a Client Computer System or a Server Computer System or both. Such a system will be made up of Electronic Hardware and would run on a Software Operating System.

Software System(s)—A set of computer programs, programming languages, procedure, rules, code that instruct Internet Website Systems, Client-Server Computer Systems, Devices, Application Software, System Software or other types of software, to perform certain tasks. Software System is widely referred to as Computer Software. These systems can be written in syntax and semantics such as C++, Perl, JavaScript, Java, ColdFusion, PHP, ASP, Flash, HTML, etc.

Distributed Computer Systems allow individuals and organizations to host vast amounts of Electronic Resources that can be accessed by their users. By using standard communication protocols such as TCP, IP, UDP, SMTP, HTTP, FTP, etc. users can access, store and exchange this data from any part of the world, irrespective of where this data is physically located. This has resulted in the exponential growth of the Internet and with about 2 billion users worldwide this also presents great challenges to data owners and its users. Among the many challenges, addressing and accessing of data, remains one the most important and one of the most difficult. No one solution can satisfy all the problems associated with addressing and accessing of an Electronic Resource.

Typically each Electronic Resource located within Distributed Computer Systems has a path; this path is referred to as the Uniform Resource Locator (URL). Therefore a URL tells us where a particular Electronic Resource is located within Distributed Computer Systems. A URL is used to address an Electronic Resource and is also used to access the Electronic Resource through Internet accessing applications and devices. URLs are mostly lengthy, non-intuitive, cumbersome and error prone to remember and type. They are commonly used as hyperlinks that allow the user to click and reach the Electronic Resource. They are also very fragile as even a slight change in the URL of the Electronic Resource will result in a broken URL.

For example, the Lenovo ThinkPad T60 Drivers and Software webpage has a URL at: http://www-307.ibm.com/pc/support/site.wss/migr-62928.html. This URL consists of many elements related to where the webpage is stored and this URL can be difficult for the user to remember and type. The use of URLs to address and access Electronic Resources becomes even more difficult when used through Mobile Devices that may have a limited keyboard size and thus extremely difficult to type.

Many URLs are dynamic in nature since the Electronic Resource is generated in real time by the Computer Servers based on certain parameters and processes. These dynamic URLs are mostly long, complex, contain many different parts that make up the URL and difficult for users to remember or type. These types of URLs mostly serve as a means of accessing Electronic Resources and not as addresses of these real time Electronic Resources. Users can navigate to these real time Electronic Resources by entering Keywords and parameter values within the Internet Website Systems input boxes or by navigating and clicking on hyperlinks; users however find it impossible to type in these dynamic URLs manually. Due to this factor there is a lack of an efficient and easy to use trigger mechanism that will allow the Computer Server to accept the users request and process it accordingly. Using such dynamic URLs as an address is highly cumbersome, inefficient and almost impossible unless such dynamic URLs are rewritten by static URLs. Therefore an alternative form of addressing is extremely essential in accessing such real time Electronic Resources.

Currently most URLs are based on a subset of the Latin based ASCII character set. Majority of Electronic Resources that are in non-Latin based native languages such as Hindi, Chinese, Japanese or Hebrew have their URLs in the Latin based ASCII character set. Therefore it becomes extremely difficult for native language users to use URLs directly as an address; instead they rely heavily on navigating through content to reach the desired Electronic Resources.

Another system, called Keyword(s), is used in the addressing and accessing of Electronic Resources on Distributed Computer Systems as they are easy to remember and use. A Keyword is a mnemonics that can be a single or combination of words. A Keyword can be used as both an Internal Keyword and as an External Keyword.

When a Keyword is typed within a Public Search Engine, the user can expect to get thousands of pages of results depending on the Keyword used and this search result will return Electronic Resources that exist across the Distributed Computer Systems on multiple individual or organizations Internet Website System or Client-Server Computer Systems. The user would then have to search through the results to get to the relevant information they need. For Example—when a Keyword such as Camera is entered in Public Search Engines such as Google.com, the Keyword—Camera will not return just one particular Electronic Resource, it will return thousands of Electronic Resources related to the Keyword—Camera. This method is a search system that lets users search through various Electronic Resources. Keywords that are used at such Public Search Engines may have thousands of Electronic Resources related to each Keyword and it is difficult for Electronic Resource owners to list their information at the very top or even on the first page of this list as there are many factors involved in listing a particular Electronic Resource on a Public Search Engines result page. One option of a better visibility on the result page is to buy the rights to a particular Keyword from the Public Search Engine, so when a user types a Keyword, a Electronic Resource can be listed in the advertisement section or sponsored links section. This section has high visibility as it is placed at prominent areas of the search result page. This method can however be expensive as only a few of such links are displayed by the Public Search Engines on each page. With the use of Keywords in Public Search Engines, users can be exposed to content, from many competing companies, relevant to that Keyword and therefore a particular company will have to put in extra effort to ensure that they have a higher visibility amongst all the content shown through the Public Search Engines. This system can also expose users to a lot of irreverent content and users will have to go through them and make a decision whether to use it or not.

When a Keyword is typed within the search box of an individual or organizations Internet Website System (non-Public Search Engine), the Keyword may still return thousands of results depending on the Keyword used, however in majority of the cases the search result will return Electronic Resources that exist only on that individual or organizations Internet Website System or Client-Server Computer Systems and not across Distributed Computer Systems. In this case the user would still be required to search through the results to get to the relevant information they need. The Keyword system can therefore be considered as part of a search system rather than an accurate addressing system such as the URL.

Due to the above limitations, many companies are using the Keyword system as an addressing system rather than just as a search system. By using Keywords in various forms they are defining specific content with these forms. For example, America on Line (AOL) uses the form “AOL Keyword: Billing”. When the user types the Keyword ‘Billing’ within the AOL system, AOL will display the appropriate Billing page content. Therefore, in this case a Keyword is used directly as an Electronic Resource address. This addressing will work only within the AOL system and not on other Internet Website Systems. For others to use a Keyword as an address, they would have to implement their own system similar to AOL. For example if WorldBank.org has to use a similar system, they will have to use a form such as “World Bank Keyword: keyword”. Also other companies are using different Keyword systems to locate Electronic Resource. Macys.com uses the form such as “Web ID: 477747”. HomeDepot.com uses the form such as “Internet #202295960”. Grainer.com uses the form such as “Grainger Item #5MB80”. Each of the above forms is unique but essentially works in a similar manner. A product is assigned a number and the form is used to highlight this product number. A user can locate the product by entering the product number in the search box of the respective company Internet Website System.

The above addressing system lacks a standard form that can be adopted by all Electronic Resource owners. The above form does not clearly inform the user the domain name of the location the users need to go and use the Keyword. It is more of a statement than a structured addressing system. Due to this, some of these forms are restricted to the company catalog, brochure or Internet Website System and cannot exist exclusively outside the company catalog, brochure or Internet Website System. For example, if the user is shown “Web ID: 477747” it would be meaningless to them unless they are looking at a Macy's catalog, brochure or Internet Website System. Thus there lacks a strong association between the products and the Internet Website System domain name brand selling that product. And for a company doing business through their Internet Website System, the company name and the domain name of the company Internet Website System, both are important brands. Also due to these limitations, Software Systems such as standalone applications, Public Search Engines and other software applications, are not be able to recognize or use this form as an address or this pattern as an address and automatically decipher these in a standardized fashion or process it any further.

### OBJECT OF THE INVENTION

Considering the huge amount of, both static and dynamic, Electronic Resources hosted on Distributed Computer Systems and in the view to obviate the above drawbacks, there was a need for a better system that could provide an efficient way of addressing and accessing Electronic Resource and at the same time ensure that such a system is less complicated for the owners and users to use.

It is the object of the present invention to provide a unique and standardized system and a method of addressing and accessing information on the Internet by allowing Internet Website system and Client-Server Computer System owners to have complete control over the way their Electronic Resources are addressed and accessed. This unique system lets owners use an alpha-numeric, multi-lingual, natural language word or a combination of words for Keywords and combine them with the website domain name thereby retaining their web brand. The system gives Internet Website system and Client-Server Computer System users an easy, simple and accurate way of accessing relevant information.

It is the object of the present invention to reduce the reliance on cumbersome static and dynamic URL's, and on the use of External Keywords in Public Search Engines.

It is further the object of the present invention to provide a unique, intuitive, accurate, evolved, standardized, robust, scalable, easy to remember and easy to use system of addressing and method of accessing Electronic Resources. It is the purpose of the present invention to provide Software Systems, such as standalone applications, Public Search Engines and other software applications, a form of addressing that these systems are able to recognize or use as an address of Electronic Resources and process further.

### SUMMARY

The present invention relates to a system and method of addressing and accessing information on the Internet comprising of a Keyword Identifier and means to interpret the Keyword Identifier, wherein said means include a Software Protocol and a Keyword Management System. The Software Protocol is a Software System. These means include the process of generating a query by the Software Protocol on the basis of the said Keyword Identifier; said query being sent to the system of the domain that the Keyword Identifier belongs to, or any other system that can interpret the query correctly. The Software Protocol then interprets the said query into a Keyword Identifier and selects the data mapped for the Keyword Identifier, which thereafter sends this result to the system using the Keyword Identifier. The Keyword Identifier is created and maintained through an Internet Website system or a Software System running on a Client-Server Computer System, as a means of addressing and accessing their Electronic Resources, using the Keyword Management System.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 represents the symbolic form of the Keyword Identifier.

FIG. 2 is a diagram showing examples of where and how the Keyword Identifier can be used.

FIG. 3 is a diagram showing how different Client-Server Computer Systems, that are part of this addressing and accessing system, are connected across the Internet.

FIG. 4 is a diagram showing how the Keyword Identifier is mapped and associated with URLs of Electronic Resources and other related information in a registry Database Software System.

FIG. 5 is a diagram showing the different elements involved in creating, maintaining and using the Keyword Identifier.

FIG. 6a is a diagram showing various processes of selection, registration and creation of a Keyword Identifier.

FIG. 6b is a diagram showing various processes of using the Keyword Identifier.

### DETAILED DESCRIPTION

The present invention relates to a system and method for addressing or accessing Electronic Resource for a Distributed Computer System, wherein the system comprises of:

a. Client-Server Computer System capable of accepting a Keyword Identifier from a user, wherein said Keyword Identifier comprises of a Keyword, followed immediately by a character ‘#’, followed immediately by a domain name, followed immediately by a ‘.’, followed immediately by a Top Level Domain (TLD) (domain name and TLD combination, domain_name.TLD, representing a Internet Website System or a Client-Server Computer System);

b. Software System for the selection, registration, creation or maintenance of said Keyword Identifier or for mapping of said Keyword Identifier with URL of Electronic Resources;

c. a Software System interpreting said Keyword Identifier when said user enters said Keyword Identifier in a Internet Website System or a Client-Server Computer System such that when said user enters said Keyword Identifier for retrieving said Electronic Resources, said Software System generates a query to be sent to said Internet Website System or a Client-Server Computer System identified by the domain name and TLD combination (domain_name.TLD) part of said Keyword Identifier;

d. a Software System implemented in said Internet Website System or a Client-Server Computer System identified by the domain name and TLD combination (domain_name.TLD) part of the Keyword Identifier accepting said query at (c) above and interpreting said query to determine the Keyword Identifier in order to retrieve from said Software System at (b) above, the Keyword, the Keyword Identifier, corresponding URL of Electronic Resources that are mapped to said Keyword Identifier; and

e. a Software System returning corresponding URL of Electronic Resources at (d) above to a user in an Internet accessing application.

Embodiments of the present invention provide systems and methods that enable Electronic Resource owners and its users to use a mnemonic, alpha-numeric word or multi-lingual word or natural language word or a combination of words and the domain name (thereby retaining their domains brand) of the Internet Website System or Client-Server Computer System that hosts the Electronic Resource, to overcome many of the challenges highlighted above and also to have complete control over the way their Electronic Resources are addressed and accessed.

Embodiments of the present invention provide systems and methods that give users an easy to remember, easy to use and accurate way of accessing Electronic Resources, by ensuring that these Electronic Resources are first effectively addressed in order for them to be effectively accessed, so users can find relevant information without relying on cumbersome URLs or searching through the thousands of pages of result in a Public Search Engine.

Embodiments of the present invention provide systems and methods of addressing and accessing Electronic Resources hosted on Distributed Computer Systems that comprises of a Keyword Identifier, Software Protocol and a Keyword Management System.

The Keyword Identifier is a unique and standardized form of Internet addressing, which denotes the address of Electronic Resources. The Keyword Identifier comprises of ‘keyword’ followed immediately by the character ‘#’, followed immediately by ‘domain_name’, followed immediately by a ‘.’ (Dot), followed immediately by ‘TLD’.

The Keyword Identifier therefore takes the form “keyword#domain_name. TLD” such that—

i) The ‘keyword’ may be an alpha-numeric word or multi-lingual word or natural language word or a combination of words that are separated by the space character or other characters.

ii) The ‘domain_name’ is the domain name or the address of a Computer Server.

iii) The ‘domain_name’ can also include any sub domain names that are used as an address of a Computer Server.

iv) The ‘TLD’ is an Internet Top-Level Domain (TLD) or an Internationalized Domain Name (IDN) or a country level domain (ccTLD) or a combination.

v) The ‘domain_name.TLD’ can be used solely to access the Internet Website System or a Client-Server Computer System, through an Internet accessing application and device, for which a Keyword Identifier is being generated.

Examples of a Keyword Identifier—

map2009-ver45#tomtom.com
printers#umiacs.umd.edu
94536#Weather.com
LK381572#macys.com [symbol]
#harvard.edu
ord to sfo#nwa.com
Food For Congo#worldbank.org [symbol]
#jnto.go.jp

This Keyword Identifier represents the address of Electronic Resources such as: i) Webpage that ends with any type of extension; ii) PDF document that ends with a .PDF extension; iii) Word document that ends with a .DOC or .DOCX extension; iv) Text document that ends with a .TXT extension; v) Image that ends with any type of extension; vi) Media file that ends with any type of extension; vii) Executable Application and Process; and viii) Any other Electronic Resources address not listed above.

The Software Protocol has two parts: The first part interprets a Keyword Identifier (KI) and generates a query. This part can be called a Keyword Identifier Protocol (KIP). The Keyword Identifier Protocol (KIP) is a Software System. The Keyword Identifier Protocol then sends this query request to a single or multiple Internet Website Systems or Client-Server Computer Systems across Distributed Computer Systems for processing. The Keyword Identifier Protocol sends this query through Internet accessing applications and devices such that they are able to transfer a query to Distributed Computer Systems. The Keyword Identifier Protocol can be configured in such a way that the query generated by the Keyword Identifier Protocol can be sent to an Internet Website System or a Client-Server Computer Systems identified by the ‘domain_name.TLD’ part of said Keyword Identifier or the query can be sent to any other Internet Website System or Client-Server Computer Systems not identified by the ‘domain_name.TLD’ part of a Keyword Identifier. The query generated by the Keyword Identifier Protocol may contain the ‘keyword’ part or the ‘domain_name.TLD’ part of a Keyword Identifier or both. It may also contain other system data generated, as parameters, within the users system such as language, country, session ID, static URL, etc., configured in the Keyword Identifier Protocol for transmission. The query generated by the Keyword Identifier Protocol can also contain multi-lingual characters.

The Keyword Identifier Protocol can be implemented in various ways such that:

i) The Software System creates a search box within an Internet Website System and when the user enters the ‘keyword’ part of a Keyword Identifier, the Software System, accepts and interprets the ‘keyword’ part of a Keyword Identifier.

ii) The Software System creates a search box within an Internet Website System and when the user enters the entire Keyword Identifier in the search box, the Software System, accepts and interprets a Keyword Identifier.

iii) The Software System enables an Internet accessing application such as a Web Browser to accept and interprets a Keyword Identifier when the user enters a Keyword Identifier in the applications address bar.

iv) The Software System creates and runs a standalone desktop or remote application to accept and interpret a Keyword Identifier when the user enters a Keyword Identifier in the applications address or command bar.

v) The Software System runs as part of a search engine system and when the user enters a Keyword Identifier in the search engine search box, the search engine triggers a query that is accepted and interpreted by the Software System as a Keyword Identifier.

vi) The Software System enables a webpage or a document to embed a Keyword Identifier within the text of the document and when the user clicks on a Keyword Identifier, the Software System accepts and interprets a Keyword Identifier.

vii) The Software System runs on a Client-Server Computer System and when a user speaks the Keyword Identifier as a voice command, the Software System accepts and interprets the Keyword Identifier voice command and converts it into a text form of the Keyword Identifier. This text form of the Keyword Identifier is then accepted and interpreted by the Software System.

The Keyword Identifier can be used, to request and retrieve Electronic Resources, through Web Browsers, Internet Website Systems, stand alone desktop software applications or in any other system that allow the user to input a Keyword Identifier and also allows the user to access and display Electronic Resources associated or mapped to a Keyword Identifier and through various devices like personal computers, mobile devices and other type of devices that can run a Keyword Identifier Protocol enabled application.

The second part of the Software Protocol interprets the query that is generated and sent by the Keyword Identifier Protocol. This part can be called the Keyword Management Protocol (KMP). The Keyword Management Protocol (KMP) is a Software System. The Keyword Management Protocol accepts the query and interprets the query back into a Keyword Identifier. It then interacts within the Keyword Management System (KMS) to find Electronic Resource location(s) (URLs) associated or mapped to a Keyword Identifier.

The Keyword Management System (KMS) is a Software System for the selection, registration, creation and maintenance of a Keyword Identifier. The Software System is installed, implemented and executed on an Internet Website System or Client-Server Computer System that is planning to use a Keyword Identifier as a means of addressing and accessing their Electronic Resources. The Keyword Management System maps a Keyword Identifier with the address of the Electronic Resource location(s) (URLs). This registration and maintenance will take place within the Client-Server Computer System hosting the Keyword Management System or other connected Client-Server Computer Systems. For Intranet users the URLs can also be local network computer addresses. In a preferred embodiment, Internet Website Systems or Client-Server Computer Systems, that have installed, implemented and execute the Keyword Management System, can allow their members to create and manage not just there their own Keyword Identifiers but also Internal Keywords. The Keyword Management System lets its users have the ability to describe attributes and behavior associated with each Electronic Resource mapped to a Keyword Identifier. They can enter information such as the title, language, country, associated keywords, description, validity date, data type, etc. within the Keyword Management System. A user can change the URLs associated or mapped to a Keyword Identifier or change the attributes associated with each Electronic Resource mapped to a Keyword Identifier. Once the Keyword Management System has been installed, implemented and executed on an Internet Website System or a Client-Server Computer System, Keyword Identifiers can be created and used to access data within that Internet Website System or within that Client-Server Computer System or any other Internet Website System or any other Client-Server Computer System.

The Keyword Management Protocol is connected to the Keyword Management System. The Keyword Management Protocol will query the Keyword Management System to find data associated or mapped to a particular Keyword Identifier. If there is a single Electronic Resource location (URL) associated with a Keyword Identifier, the Keyword Management Protocol processes this request by opening up the single URL in the user's browser. If multiple URLs are associated or mapped to a Keyword Identifier then the Keyword Management Protocol will generate a webpage listing all the URLs associated or mapped to a Keyword Identifier along with a title, description, URL (in the form of a URL hyperlink), etc. The user then sees this list in their browser window. An error message may or may not be returned to the user if no URLs are associated or mapped to a particular Keyword Identifier. Instead the user can be provided with a list of possible alternatives for that particular Keyword Identifier.

The Keyword Management System can be installed, implemented and executed by the Internet Website System or Client-Server Computer System that is mentioned in the ‘domain_name.TLD ’ part of a Keyword Identifier or by an Internet Website System or Client-Server Computer System that creates and manages Keyword Identifier for multiple, other, Internet Website Systems or Client-Server Computer Systems. The query generated by the Keyword Identifier Protocol can be sent to the domain name mentioned in a Keyword Identifier or to other domain names that manage Keyword Identifiers of multiple, other, Internet Website Systems or Client-Server Computer Systems.

The Keyword Identifier can be used to trigger a dynamic process within a Computer Server that is running the Keyword Management System. By entering the ‘keyword’ part of the Keyword Identifier or the Keyword Identifier itself, the user can trigger various Software System processes that are initiated in real time and content is dynamically generated without the user being concerned about the dynamic URLs that the system processes to allow the user to access real time Electronic Resources. Such a trigger mechanism will fill the void that exists in the addressing of dynamic URLs and real time content generation and will provide both the users and the Electronic Resource owners a credible and accurate form of addressing real time content.

The Keyword Management System lets the Internet Website System owner generate keywords, which are part of the Keyword Identifier, that point to dynamic URLs. Say there is a promotion by American Airlines from ORD to SFO sector for a fare of $99. Now all American Airlines has to do is register a Keyword Identifier ORD to SFO#AA.COM in their Keyword Management System and when their customers come to AA.com and type in this Keyword Identifier on their Internet Website System or any other application, the Keyword Identifier Protocol at AA.com will interpret the Keyword Identifier and send the query to the Keyword Management Protocol implemented at AA.com where the query is computed and the associated page is displayed to the user. It may not be possible to use a Public Search Engine to accurately get to this deal page and it may not be possible to type the dynamic URL to get to this deal page, so the user instead has go to AA.com to avail the use of such special promotions by clicking on the links, navigating or if AA.com displays this promotion on the first page itself (which will not be possible if they have 10 other sectors with the same deal) or by navigating the AA.com Internet Website System content. Now by using a Keyword Identifier the user can easily access the deals page and American Airline can have an associated Keyword Identifier for each sector. The Keyword Identifier thus works as a trigger mechanism to let AA.com generate content by the use of simple Keywords that are part of the Keyword Identifier and are known to both the users and to AA.com Internet Website System or Client-Server Computer System as a specific address of a specific content. The users can hold on to this address for future use and can come back and rely on this address to get them to the desired content, without relying on search or navigating through the Internet Website System to locate the desired content.

A preferred embodiment of the present invention will now be described with reference to the figures accompanying the specification wherein:

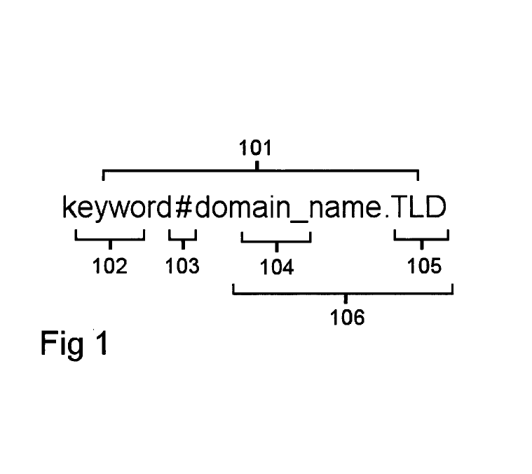

FIG. 1 represents the symbolic form of the Keyword Identifier.

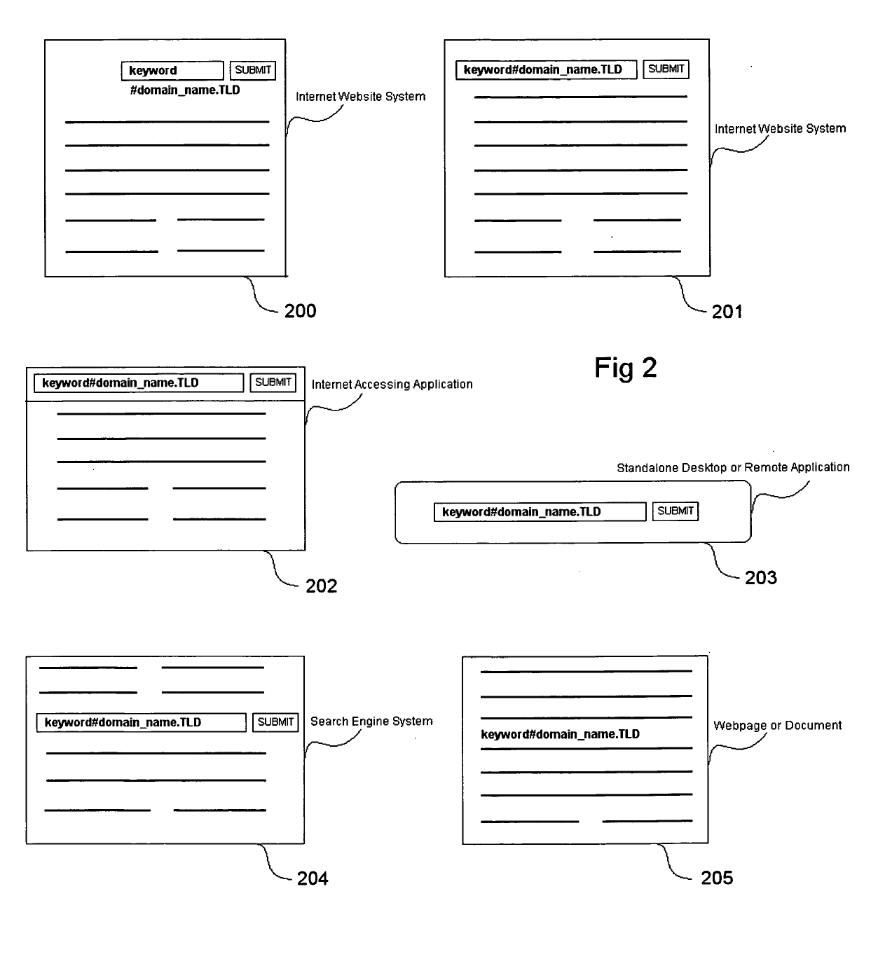

FIG. 2 is a diagram showing examples of where and how the Keyword Identifier can be used.

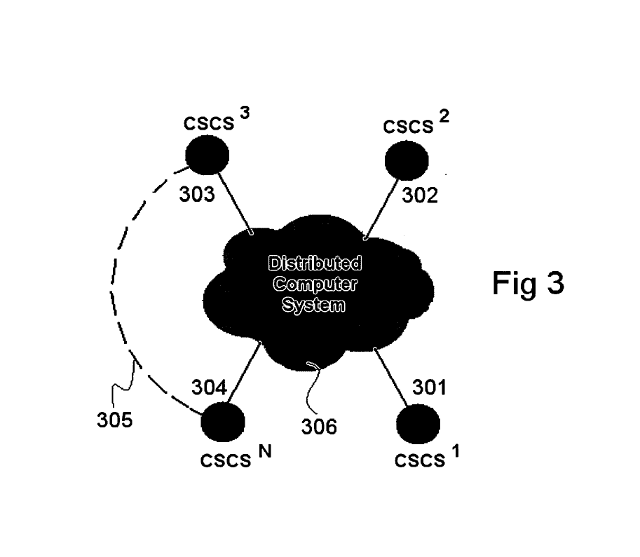

FIG. 3 is a diagram showing how different Client-Server Computer Systems, that are part of this addressing and accessing system, are connected across the Internet.

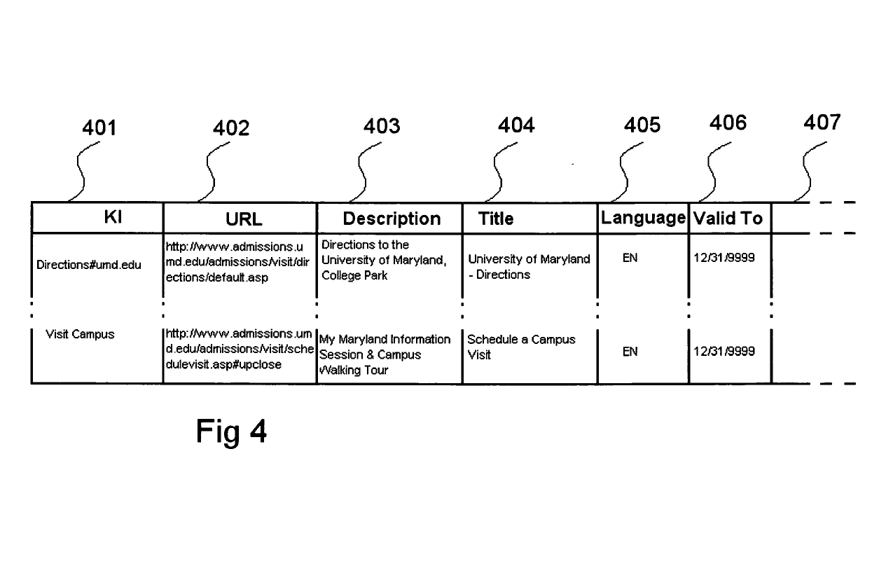

FIG. 4 is a diagram showing how the Keyword Identifier is mapped and associated with URLs of Electronic Resources and other related information in a registry Database Software System.

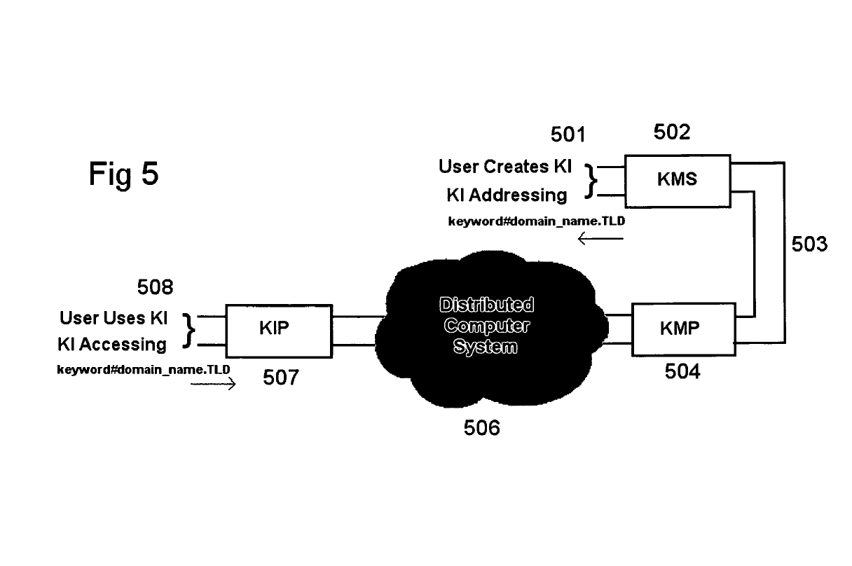

FIG. 5 is a diagram showing the different elements involved in creating, maintaining and using the Keyword Identifier.

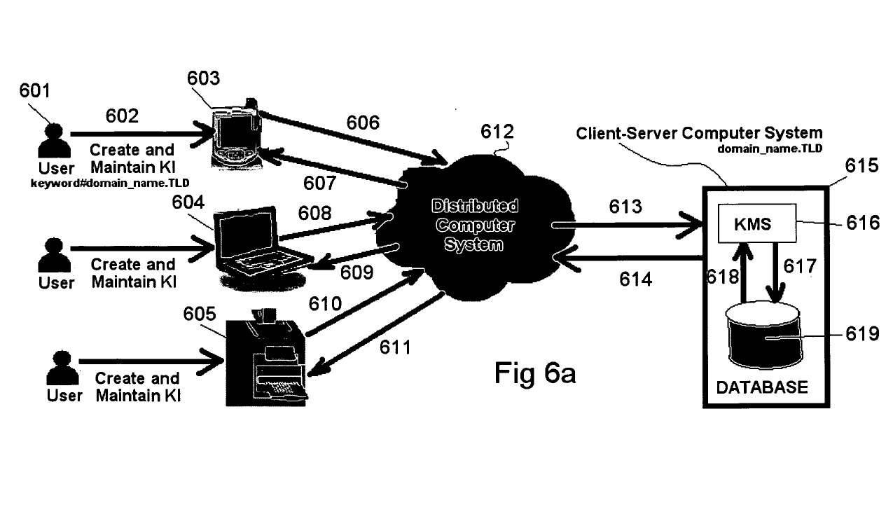

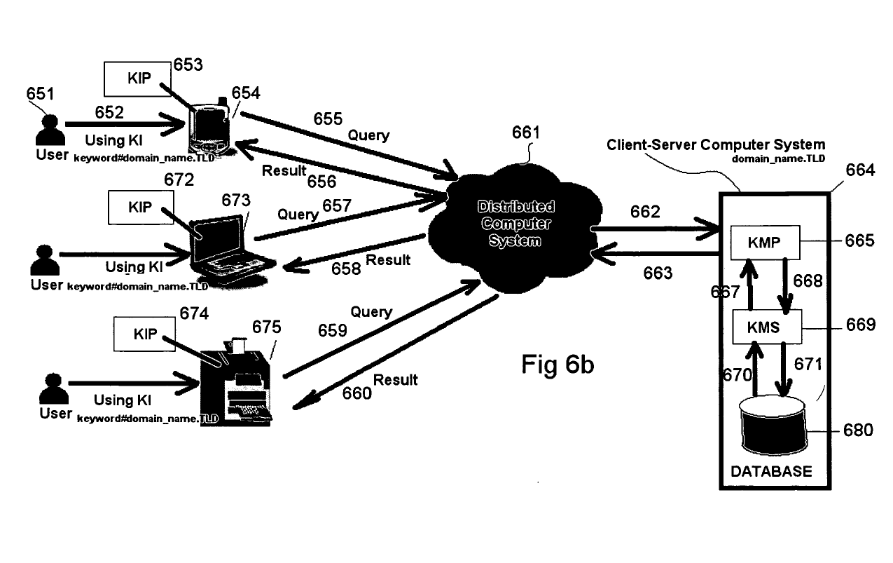

FIG. 6a is a diagram showing various processes of selection, registration and creation of a Keyword Identifier.

FIG. 6b is a diagram showing various processes of using the Keyword Identifier.

### DETAILED DESCRIPTION OF THE PREFERRED EMBODIMENT

FIG. 1 represents the form of the Keyword Identifier. In this form 101 represents the Keyword Identifier in its entirety. This form is made with a combination of 4 parts—the keyword (102), the # character (103), the domain_name (104) and the TLD (105). The keyword (102) part may be an alpha-numeric word or multi-lingual word or natural language word or a combination of words that are separated by the space character or other characters. The domain_name (104) part is the domain name or the address of a Computer Server. The domain_name (104) can also include any sub domain names that are used as a Computer Server name. The TLD (105) part is an Internet Top-Level Domain (TLD) or an Internationalized Domain Name (IDN) or a country level domain (ccTLD) or a combination. The domain_name (104) and the TLD (105) parts in combination (106) can be used solely to access the Internet Website System, through an Internet accessing application and device, for which a Keyword Identifier is being generated.

Therefore the Keyword Identifier representation of FIG. 1 can be used to define Keyword Identifiers. Some examples are:

94536#weather.com

Batch-AA05252008#sap.tyota.co.jp

SM790707#macys.com

In these examples the form of the Keyword Identifier is as defined in the embodiment but the values of the Keyword and the domain_name. TLD part can change based on various factors. The keyword 94536 can represent a zip code, the keyword Batch-AA05252008 can represent a process, and the keyword SM7779 can represent a product number.

FIG. 2 is a block diagram depicting how and where a Keyword Identifier may be used. When a user uses the Keyword Identifier to access Electronic Resources, the Keyword Identifier becomes a means of both addressing and accessing Electronic Resources. Any system that implements the Keyword Identifier Protocol and has the ability to connect to Distributed Computer Systems can accept and interpret the Keyword Identifier. Examples of few of these different systems that may implement the Keyword Identifier Protocol and use the Keyword Identifier to access Electronic Resources are described in FIG. 2.

In 200, the Keyword Identifier Protocol creates a search box within an Internet Website System and when the user enters the ‘keyword’ part of a Keyword Identifier, the Software System, accepts and interprets the ‘keyword’ part of a Keyword Identifier. In this case, the Keyword Identifier Protocol assumes that the ‘keyword’ part of the Keyword Identifier belongs to the same Internet Website System where the keyword is being entered. It then sends a query to this Internet Website System's Keyword Management Protocol.

In 201 the Keyword Identifier Protocol creates a search box within an Internet Website System and when the user enters the entire Keyword Identifier in the search box, the Software System, accepts and interprets a Keyword Identifier. In this case, the Keyword Identifier Protocol generates a query that is sent to the Keyword Management Protocol belonging to the system represented by the ‘domain_name.TLD’ part of the Keyword Identifier.

In 202 the Keyword Identifier Protocol enables an Internet accessing application such as a Web Browser to accept and interpret a Keyword Identifier when the user enters a Keyword Identifier in the applications address bar. In this case, the Keyword Identifier Protocol generates a query that is sent to the Keyword Management Protocol belonging to the system represented by the ‘domain_name.TLD’ part of the Keyword Identifier.

In 203 the Keyword Identifier Protocol creates and runs a standalone desktop or remote application to accept and interpret a Keyword Identifier when the user enters a Keyword Identifier in the applications address or command bar. In this case, the Keyword Identifier Protocol generates a query that is sent to the Keyword Management Protocol belonging to the system represented by the ‘domain_name.TLD’ part of the Keyword Identifier.

In 204 the Keyword Identifier Protocol runs as part of a search engine system and when the user enters a Keyword Identifier in the search engine search box, the search engine triggers a query that is accepted and interpreted by the Software System as a Keyword Identifier. In this case, the Keyword Identifier Protocol generates a query that is sent to the Keyword Management Protocol belonging to the system represented by the ‘domain_name.TLD’ part of the Keyword Identifier.

In 205 the Keyword Identifier Protocol enables a webpage or a document to embed a Keyword Identifier within the text of the document and when the user clicks on a Keyword Identifier, the Software System accepts and interprets a Keyword Identifier. In this case, the Keyword Identifier Protocol generates a query that is sent to the Keyword Management Protocol belonging to the system represented by the ‘domain_name.TLD’ part of the Keyword Identifier.

FIG. 3 is a diagram showing multiple Client-Server Computer Systems—301 302 303 and 304, all inter-connected to each other across Distributed Computer Systems. Each of these Client-Server Computer Systems can implement either the Keyword Identifier Protocol or the Keyword Management Protocol and Keyword Management System or all three software systems. 301 302 303 and 304 can be devices such as Servers, Personal Computers, Laptops, Notebooks, Tablets, Mobile Devices, Internet TV, Gaming Systems, Security Systems, PIM Consoles, Network Appliances, Data Storage Devices, Transportation On-Board Computers, etc. which are capable of storing data, computing, providing and performing various complex services and are able to connect to Distributed Computer Systems. Such a system can perform functions of either a Client Computer System or a Server Computer System or both. Such a system will be made up of Electronic Hardware and would run on a Software Operating System.

When 301 302 303 and 304 can implement only the Keyword Identifier Protocol, in which case the users from these systems will only be able to use the Keyword Identifier.

When 301 302 303 and 304 can also implement the Keyword Management Protocol and Keyword Management System, in which case these systems can accept a query that contains parts of the Keyword Identifier and interpret this query to generate a Keyword Identifier and get the associated Electronic Resources mapped to the Keyword Identifier. The user in this case can also create and maintain Keyword Identifiers by accessing the implemented Keyword Management System.

When 301 302 303 and 304 can implement all three systems, Keyword Identifier Protocol, Keyword Management Protocol and Keyword Management System, in which case the Client-Server Computer Systems is not only able to create and maintain Keyword Identifiers, but is also able to access Electronic Resources using a Keyword Identifier. Therefore it is desired that every Client-Server Computer Systems that implements the Keyword Management Protocol and Keyword Management System also implement the Keyword Identifier Protocol. The Keyword Identifier Protocol can be implemented in many more systems since the purpose of the Keyword Identifier Protocol is to create a place holder where the Keyword Identifier can be entered, interpreted and sent as a query. This differs from the use of Keyword Management Protocol and Keyword Management System which are systems where the query is accepted, interpreted and associated links to Electronic Resources are maintained and derived from.

The FIG. 3 only depicts few Client-Server Computer Systems and so 305 suggest that there can be multiple systems that can implement the technology presented in this patent thereby enabling these Client-Server Computer Systems to communicate with each other by using a Keyword Identifier.

FIG. 4 is a diagram showing the mapping and association of the Keyword Identifier with the Electronic Resource location(s) (URLs) and other related information in a registry Database Software System.

A Keyword Management System is used for the selection, registration, creation and maintenance of a Keyword Identifier and for the mapping of the ‘keyword’ part of the Keyword Identifier or a Keyword Identifier with the Electronic Resource location(s) (URLs). The Keyword Management System is a software system that can let the user select and enter values for fields shown in 401 402 403 404 405. The Keyword Management System can be connected to a Database Software System or can be connected to a Software System that allows the Keyword Management System to store data associated with the registration, creation and maintenance of a Keyword Identifier. The ‘keyword’ part of the Keyword Identifier or the entire Keyword Identifier itself can be entered into the system. If only the ‘keyword’ part is entered, the Keyword Management System accepts the Keyword and assumes that the user is trying to register a Keyword Identifier that belongs to the Client-Server Computer System where the Keyword Management System is implemented. So if a user registers a Keyword Batch-AA05252008 within the Keyword Management System of a Client-Server Computer System sap.tyota.co.jp, then the entire Keyword Identifier would be “Batch-AA05252008#sap.tyota.co.jp”. Once this Keyword Identifier is registered, users can use this Keyword Identifier from any Client-Server Computer System that has implemented the Keyword Identifier Protocol and when the user enters the Keyword Identifier: “Batch-AA05252008#sap.tyota.co.jp”, the query with the Keyword “Batch-AA05252008” will be sent to the Client-Server Computer System “sap.tyota.co.jp”. Similarly when a user uses a Keyword Identifier “SM790707#macys.com” to access Electronic Resources associated with this Keyword Identifier, the Keyword Identifier Protocol system will send the Keyword “SM790707” to Client-Server Computer System “macys.com”.

Similarly, other related information can also be entered by the user when creating or maintaining a Keyword Identifier. 401 402 403 404 405 406 are examples of various fields that the user may have to enter values for. 401 and 402 are important fields and may even be mandatory for the purpose of this invention since the Keyword Identifier is used as the address (URL) of Electronic Resource(s).

These field value once entered by the user can be stored in a Database Software System or in simple text files or any other method thereby signifying that the exact method of storage is not important but what is important is the association of the ‘keyword’ part of the Keyword Identifier or the entire Keyword Identifier with the address (URL) of Electronic Resource(s). 407 illustrates that there can be many more fields that the user can choose to include in the registration process, based on their needs.

FIG. 5 describes all the elements of this invention and how they connect with each other for the purpose of creating and using a Keyword Identifier. At 501, a user starts out by using the Keyword Management System (502) to create or maintain a Keyword Identifier. At this point the user is defining the characteristics of a Keyword Identifier by entering addresses of Electronic Resources mapped to the Keyword Identifier and other information as described in FIG. 4. Once the registration process is complete the user has a Keyword Identifier defined and ready for use as an address. Hence at 501, the user is still at the addressing stage. The Keyword Management System (502) Software System is connected to the Keyword Management Protocol (504) Software System. At 508, a user starts out by entering the ‘keyword’ part of the Keyword Identifier or the Keyword Identifier in a Client-Server Computer System that has implemented a Keyword Identifier Protocol (507). 507 accept and interpret the Keyword Identifier and generate a query. This query is sent over Distributed Computer Systems (506) to the Client-Server Computer System represented by the ‘domain_name.TLD’ part of the Keyword Identifier. Within this Client-Server Computer System the query will be accepted and interpreted by the Keyword Management Protocol (504) and a Keyword Identifier will be derived from the query. This in turn will be sent to the Keyword Management System (502). Keyword Management System will then send the associate information, as results, back to Keyword Management Protocol which is then sent back to the system that generated the query via the Keyword Identifier Protocol. The results can take up various forms depending upon how the user described the characteristics of the Keyword Identifier. One way the result can be displayed is when only one address of the Electronic Resource is returned and the Electronic Resource is displayed to the user in an Internet accessing application such as a Web Browser. The other way is when a Keyword Identifier has multiple addresses of Electronic Resources associated; in which case all the addresses along with the other information associated to these addresses would be displayed to the user in an Internet accessing application such as a Web Browser.

FIG. 6a is a diagram showing various processes of selection, registration and creation of a Keyword Identifier. 603 604 605 are various devices through which a user (601) can access the Keyword Management System and create a Keyword Identifier. FIG. 6a illustrates this process where the user remotely logs on into the Client-Server Computer System that has implemented the Keyword Management System. This figure assumes that the user has access and authorization to enter the Client-Server Computer System and to create a Keyword Identifier. If the user has physical access and is working on the Client-Server Computer System that has implemented the Keyword Management System, the user will be able to create Keyword Identifiers without going through the Distributed Computer Systems. 615 consist of both the Keyword Management System and Database Software Systems. The Database Software System can also exist on a separate Client-Server Computer System.

FIG. 6b is a diagram showing various processes of using the Keyword Identifier. 654 673 675 are the various devices through which a user (651) can use a Keyword Identifier to access Electronic Resources. 653 672 674 illustrate the Keyword Identifier Protocol Software System implemented on each of these devices trying to use the Keyword Identifier. Once the user enters the Keyword Identifier in 654 673 675, a query is generated. This is depicted by 655 657 659. These queries are sent over the Distributed Computer Systems to the Client-Server Computer Systems identified by the ‘domain_name.TLD’ part of the Keyword Identifier. 664 consist of the Keyword Management Protocol, Keyword Management System and Database Software Systems. The Database Software System can also exist on a separate Client-Server Computer System. After processing within 664, the results are sent back via 663 to the originating devices as depicted by 656 658 660.

Although the invention has been described in terms of particular embodiments and applications, one of ordinary skill in the art, in light of this teaching, can generate additional embodiments and modifications without departing from the spirit of or exceeding the scope of the claimed invention. It should be emphasized that the above-described embodiments of the present invention, particularly any “preferred” embodiments, are merely possible examples of the invention of implementations, merely set forth for a clear understanding of the principles of the invention. Accordingly, it is understood that the drawings and descriptions herein are by way of example to facilitate comprehension of the invention and should not be construed to limit the scope thereof.

What is claimed is:

1. A user apparatus for accessing an electronic resource via a distributed computer network, the user apparatus comprising:
a user interface for receiving a user input;
a computer processor configured to execute computer instructions; and
an application program comprising computer instructions executable by the computer processor, wherein the application program causes the user apparatus to:
receive from the user interface the user input;
detect in the received user input a hash key character “#”, a potential keyword, and a potential domain name;
generate from the received user input a keyword identifier having the form ‘keyword#domain_name.TLD’, wherein the ‘keyword’ field represents the potential keyword, the ‘domain_name’ field represents the potential domain name, the ‘TLD’ field represents a Top Level Domain; and the “#” field is the hash key character used as a separator between the ‘keyword’ field and the ‘domain_name’ field;
establish a communication link between the application program and a proprietary keyword management server associated with the application program; and
transmit the keyword identifier to the proprietary keyword management server,
wherein the proprietary keyword management server is configured to access a database storing a plurality of proprietary keyword records and to use the keyword identifier to access a proprietary keyword record that matches the ‘domain_name.TLD’ part of the keyword identifier.

2. The user apparatus of claim 1, wherein the application program further causes the user apparatus to receive from the proprietary keyword management server at least one electronic resource identifier associated with a matching proprietary keyword record that matches the ‘domain_name.TLD’ part of the keyword identifier.

3. The user apparatus of claim 2, wherein the proprietary keyword management server uses the ‘keyword’ field part of the keyword identifier to select the at least one electronic resource identifier from the matching proprietary keyword record.

4. The user apparatus of claim 3, wherein the ‘keyword’ field is mapped to a location in the distributed computer network associated with the at least one electronic resource identifier.

5. The user apparatus of claim 3, wherein the at least one electronic resource identifier comprises a Uniform Resource Locator (URL).

6. A method in a user apparatus for accessing an electronic resource via a distributed computer network, the method comprising:
receiving a user input in a user interface of the user apparatus;
receiving the user input from the use interface in an application program;
in the user application:
detecting in the received user input a hash key character “#”, a potential keyword, and a potential domain name;
generating from the received user input a keyword identifier having the form ‘keyword#domain_name.TLD’, wherein the ‘keyword’ field represents the potential keyword, the ‘domain_name’ field represents the potential domain name, the ‘TLD’ field represents a Top Level Domain; and the “#” field is the hash key character used as a separator between the ‘keyword’ field and the ‘domain_name’ field;
establishing a communication link between the application program and a proprietary keyword management server associated with the application program; and
transmitting the keyword identifier to the proprietary keyword management server,
wherein the proprietary keyword management server is configured to access a database storing a plurality of proprietary keyword records and to use the keyword identifier to access a proprietary keyword record that matches the ‘domain_name.TLD’ part of the keyword identifier.

7. The method of claim 6, further comprising, in the application program, receiving from the proprietary keyword management server at least one electronic resource identifier associated with a matching proprietary keyword record that matches the ‘domain_name.TLD’ part of the keyword identifier.

8. The method of claim 7, wherein the proprietary keyword management server uses the ‘keyword’ field part of the keyword identifier to select the at least one electronic resource identifier from the matching proprietary keyword record.

9. The method of claim 8, wherein the ‘keyword’ field is mapped to a location in the distributed computer network associated with the at least one electronic resource identifier.

10. The method of claim 8, wherein the at least one electronic resource identifier comprises a Uniform Resource Locator (URL).

11. A keyword management server for accessing an electronic resource via a distributed computer network comprising:
a computer processor configured to execute computer instructions; and
a server program comprising computer instructions executable by the computer processor; and
a proprietary keyword database configured to store a plurality of proprietary keyword records,
wherein the server program causes the keyword management server to:
establish a communication link between the keyword management server and an application program associated with the keyword management server executed on a remote user apparatus;
receive from the application program executed on the remote user apparatus a keyword identifier having the form ‘keyword#domain_name.TLD’, wherein the ‘keyword’ field represents a keyword, the ‘domain_name’ field represents a domain name, the ‘TLD’ field represents a Top Level Domain; and the “#” field is the hash key character used as a separator between the ‘keyword’ field and the ‘domain_name’ field; and
access in the proprietary keyword database one of the plurality of proprietary keyword records that matches the ‘domain_name.TLD’ part of the keyword identifier.

12. The keyword management server of claim 11, wherein the server program causes the keyword management server to retrieve from the matching proprietary keyword record at least one electronic resource identifier and to transmit the retrieved at least one electronic resource identifier to the remote user apparatus.

13. The keyword management server of claim 12, wherein the server program causes the keyword management server to retrieve the at least one electronic resource identifier from the matching proprietary keyword record using the ‘keyword’ field part of the keyword identifier.

14. The keyword management server of claim 13, wherein the ‘keyword’ field is mapped to a location in the distributed computer network associated with the at least one electronic resource identifier.

15. The keyword management server of claim 13, wherein the at least one electronic resource identifier comprises a Uniform Resource Locator (URL).

16. A method in a keyword management server for accessing an electronic resource via a distributed computer network, the method comprising:
storing in a proprietary keyword database a plurality of proprietary keyword records;
establishing a communication link between the keyword management server and an application program associated with the keyword management server executed on a remote user apparatus;
receiving from the application program executed on the remote user apparatus a keyword identifier having the form ‘keyword#domain_name.TLD’, wherein the ‘keyword’ field represents a keyword, the ‘domain_name’ field represents a domain name, the ‘TLD’ field represents a Top Level Domain; and the “#” field is the hash key character used as a separator between the ‘keyword’ field and the ‘domain_name’ field; and
accessing in the proprietary keyword database one of the plurality of proprietary keyword records that matches the ‘domain_name.TLD’ part of the keyword identifier.

17. The method of claim 16, further comprising:
retrieving from the matching proprietary keyword record at least one electronic resource identifier; and
transmitting the retrieved at least one electronic resource identifier to the remote user apparatus.

18. The method of claim 17, wherein retrieving the at least one electronic resource identifier from the matching proprietary keyword record comprises retrieving the at least one electronic resource identifier from the matching proprietary keyword record using the ‘keyword’ field part of the keyword identifier.

19. The method of claim 18, wherein the ‘keyword’ field is mapped to a location in the distributed computer network associated with the at least one electronic resource identifier.

20. The method of claim 18, wherein the at least one electronic resource identifier comprises a Uniform Resource Locator (URL).
